(19) United States
(12) Patent Application Publication
(10) Pub. No.: US 2011/0169457 A1
(43) Pub. Date: Jul. 14, 2011

(54) BATTERY PACK

(76) Inventors: Masahiro Mitani, Chiba-shi (JP); Takakazu Ozawa, Chiba-shi (JP)

(21) Appl. No.: 12/984,210

(22) Filed: Jan. 4, 2011

(30) Foreign Application Priority Data
Jan. 8, 2010 (JP) 2010-003353

(51) Int. Cl. H02J 7/04

(52) U.S. Cl. 320/134

(57) ABSTRACT

Provided is a battery pack capable of implementing temperature protection with ease. Regardless of whether or not a battery protection IC (11) has a terminal for temperature protection of a battery pack (10), the battery pack (10) is capable of implementing the temperature protection by using an N type FET (15) and a resistor (17). Accordingly, there is no influence of the presence/absence of the terminal on implementing the temperature protection of the battery pack (10). Therefore, the battery pack (10) may implement the temperature protection with ease.

### RELATED APPLICATIONS

This application claims priority under 35 U.S.C. §119 to Japanese Patent Application No. 2010-003353 filed on Jan. 8, 2010, the entire content of which is hereby incorporated by reference.

### BACKGROUND OF THE INVENTION

1. Field of the Invention

The present invention relates to a battery pack including a temperature switch IC.

2. Description of the Related Art

A conventional battery pack is described. FIG. 5 is a block diagram illustrating the conventional battery pack.

A battery protection IC 91 controls N type FETs 93 and 94, respectively, based on a voltage of a battery 98. An overcharge voltage indicating that the battery 98 is in an overcharge state and an overdischarge voltage indicating that the battery 98 is in an overdischarge state are set therein in advance, and if the voltage of the battery 98 becomes equal to or higher than the overcharge voltage, a voltage of a charge control terminal CO is controlled to Low so that the N type FET 94 is turned OFF to stop the charge to the battery 98. On the other hand, if the voltage of the battery 98 becomes equal to or lower than the overdischarge voltage, a voltage of a discharge control terminal DO is controlled to Low so that the N type FET 93 is turned OFF to stop the discharge from the battery 98.

Further, a temperature switch IC 92 controls the N type FET 94 based on temperature. An abnormal temperature is set therein in advance, and if the temperature reaches to the abnormal temperature, an output terminal DET of the temperature switch IC 92 (control terminal DS of the battery protection IC 91) becomes High, and the voltage of the charge control terminal CO is controlled to Low so that the N type FET 94 is turned OFF to stop the charge to the battery 98 (see, for example, Japanese Patent Application Laid-open No. 2004-120849).

However, in the technology disclosed in Japanese Patent Application Laid-open No. 2004-120849, the battery protection IC 91 requires the control terminal DS for the temperature protection of the battery pack. In other words, this technology is applicable to the battery pack only when the control terminal DS is provided in the battery protection IC 91 of the battery pack. Without the control terminal DS, this technology is not applicable.

In view of this, a battery pack capable of implementing temperature protection with ease regardless of the presence/absence of the control terminal DS is sought after.

### SUMMARY OF THE INVENTION

The present invention has been made in view of the above-mentioned problem, and provides a battery pack capable of implementing temperature protection with ease.

In order to solve the above-mentioned problem, the present invention provides a battery pack including: a temperature switch IC for supplying an output current when detecting an abnormal temperature; a charge control FET and a discharge control FET which are connected in series in a charge/discharge path of a battery; a first resistor for generating a voltage based on the output current; a transistor for turning OFF the charge control FET based on the voltage generated across the first resistor; and a battery protection IC for monitoring a charge state of the battery and controlling the charge control FET and the discharge control FET.

According to the present invention, the battery protection IC requires no terminal for temperature protection, and hence the battery pack may implement the temperature protection with ease.

### BRIEF DESCRIPTION OF THE DRAWINGS

In the accompanying drawings:

FIG. 1 is a block diagram illustrating a battery pack of an embodiment of the present invention;

FIG. 2 is a block diagram illustrating a battery protection IC of an embodiment of the present invention;

FIG. 3 is a block diagram illustrating a temperature switch IC of an embodiment of the present invention;

FIG. 4 is a block diagram illustrating another battery pack of an embodiment of the present invention; and

FIG. 5 is a block diagram illustrating a conventional battery pack.

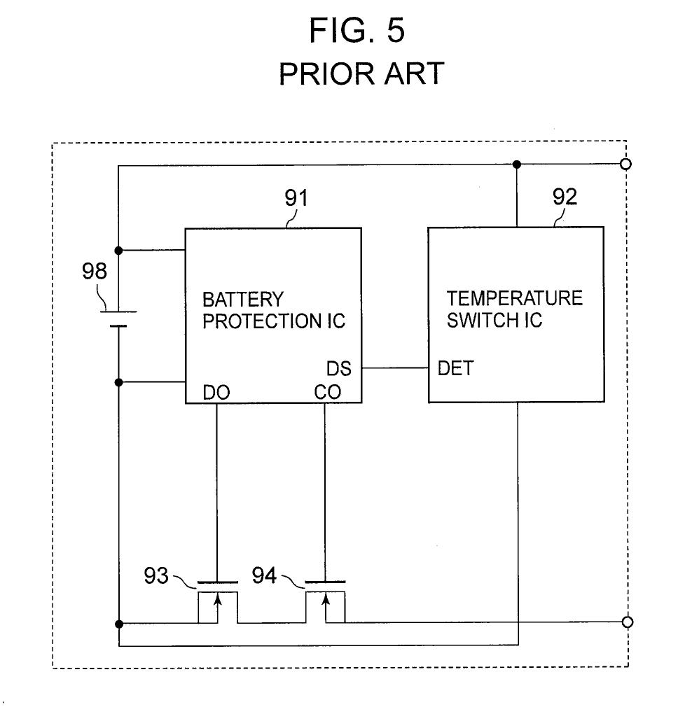

### DETAILED DESCRIPTION OF THE PREFERRED EMBODIMENTS

Now, referring to the accompanying drawings, an embodiment of the present invention is described.

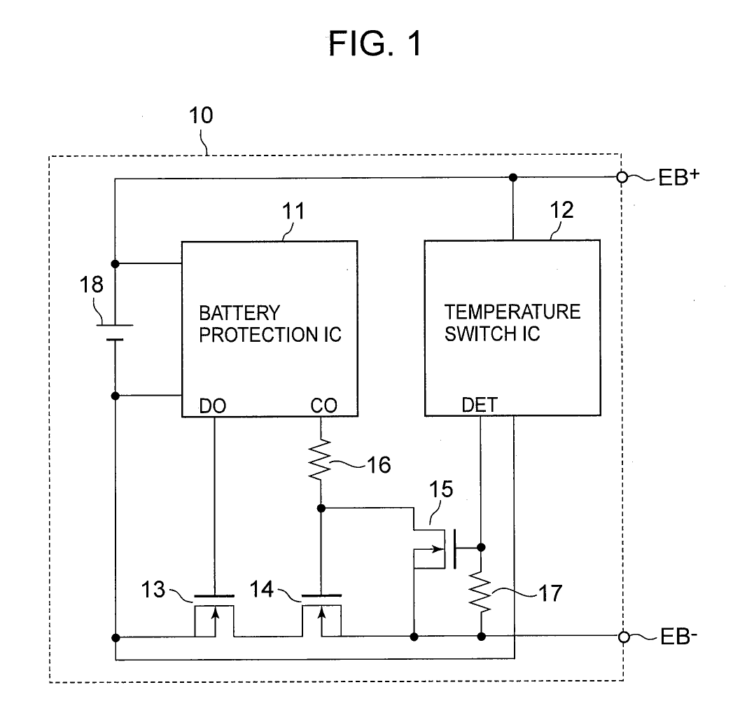

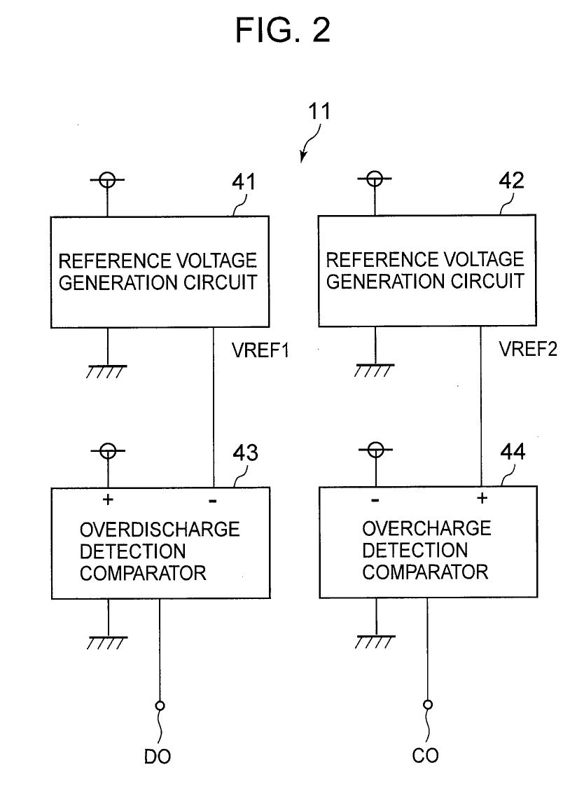

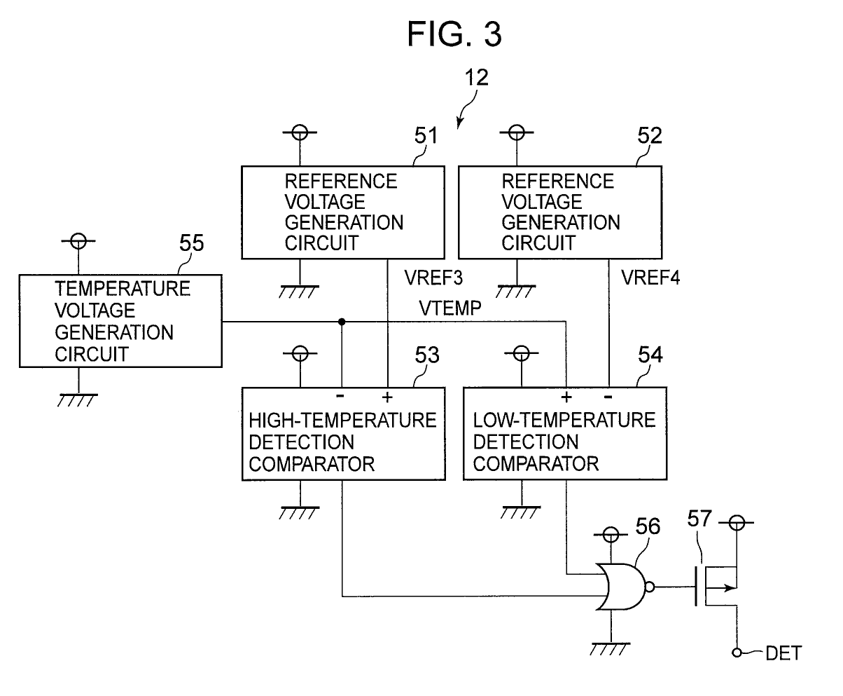

FIG. 1 is a block diagram illustrating the battery pack of an embodiment of the present invention. FIG. 2 is a block diagram illustrating a battery protection IC of an embodiment of the present invention. FIG. 3 is a block diagram illustrating a temperature switch IC of an embodiment of the present invention.

As illustrated in FIG. 1, a battery pack 10 includes a battery protection IC 11, a temperature switch IC 12, N type FETs 13 to 15, resistors 16 and 17, and a battery 18. The battery pack 10 further includes an external terminal EB+ and an external terminal EB−.

As illustrated in FIG. 2, the battery protection IC 11 includes reference voltage generation circuits 41 and 42, an overcharge detection comparator 44, and an overdischarge detection comparator 43. The battery protection IC 11 further includes a power supply terminal, a ground terminal, a charge control terminal CO, and a discharge control terminal DO.

As illustrated in FIG. 3, the temperature switch IC 12 includes a temperature voltage generation circuit 55, reference voltage generation circuits 51 and 52, a high-temperature detection comparator 53, a low-temperature detection comparator 54, a NOR circuit 56, and a PMOS transistor 57. Although not illustrated, the temperature voltage generation circuit 55 is formed of a PNP bipolar transistor and the like. The temperature switch IC 12 further includes a power supply terminal, a ground terminal, and an output terminal DET.

In the battery protection IC 11, the power supply terminal is connected to a positive terminal of the battery 18, the ground terminal is connected to a negative terminal of the battery 18, the discharge control terminal DO is connected to a gate of the N type FET 13, and the charge control terminal CO is connected to a gate of the N type FET 14 via the resistor 16. In the temperature switch IC 12, the power supply terminal is connected to the positive terminal of the battery 18, the ground terminal is connected to the negative terminal of the battery 18, and the output terminal DET is connected to a gate of the N type FET 15.

The resistor 16 is disposed between the charge control terminal CO and a connection point between the gate of the N type FET 14 and a drain of the N type FET 15. The resistor 17 is disposed between the external terminal EB− and a connection point between the output terminal DET and the gate of the N type FET 15. The N type FET 13 has a source and a back gate which are connected to the negative terminal of the battery 18, and a drain connected to a drain of the N type FET 14. The N type FET 14 has a source and a back gate which are connected to the external terminal EB−. The N type FET 15 has a source and a back gate which are connected to the external terminal EB−. The external terminal EB+ is connected to the positive terminal of the battery 18.

The reference voltage generation circuits 41 and 42, the overcharge detection comparator 44, and the overdischarge detection comparator 43 are each disposed between the power supply terminal and the ground terminal. The overcharge detection comparator 44 has a non-inverting input terminal connected to an output terminal of the reference voltage generation circuit 42, an inverting input terminal connected to the power supply terminal, and an output terminal connected to the charge control terminal CO. The overdischarge detection comparator 43 has a non-inverting input terminal connected to the power supply terminal, an inverting input terminal connected to an output terminal of the reference voltage generation circuit 41, and an output terminal connected to the discharge control terminal DO.

The temperature voltage generation circuit 55, the reference voltage generation circuits 51 and 52, the high-temperature detection comparator 53, the low-temperature detection comparator 54, and the NOR circuit 56 are each provided between the power supply terminal and the ground terminal. The high-temperature detection comparator 53 has a non-inverting input terminal connected to an output terminal of the reference voltage generation circuit 51 and an inverting input terminal connected to an output terminal of the temperature voltage generation circuit 55. The low-temperature detection comparator 54 has a non-inverting input terminal connected to the output terminal of the temperature voltage generation circuit 55 and an inverting input terminal connected to an output terminal of the reference voltage generation circuit 52. The NOR circuit 56 has a first input terminal connected to an output terminal of the high-temperature detection comparator 53, a second input terminal connected to an output terminal of the low-temperature detection comparator 54, and an output terminal connected to a gate of the PMOS transistor 57. The PMOS transistor 57 has a source and a back gate which are connected to the power supply terminal, and a drain connected to the output terminal DET.

When detecting an abnormal temperature, the temperature switch IC 12 supplies an output current. Based on the output current, the resistor 17 generates a voltage. By the voltage generated across the resistor 17, the N type FET 15 turns OFF the N type FET 14 for charge control. Further, when the battery 18 reaches an overcharge state, the battery protection IC 11 operates so that the N type FET 14 is turned OFF, and when the battery 18 reaches an overdischarge state, the battery protection IC 11 operates so that the N type FET 13 for discharge control is turned OFF.

Next, an operation of the battery pack 10 is described.

[Operation when Battery 18 is in Overcharge State]

A charger (not shown) is connected to the battery pack 10. The reference voltage generation circuit 42 generates a reference voltage VREF2, which corresponds to an overcharge voltage indicating that the battery 18 is in the overcharge state. The overcharge detection comparator 44 compares a divided voltage of the battery 18 with the reference voltage VREF2, and inverts an output voltage thereof depending on the comparison result. Specifically, if the divided voltage of the battery 18 becomes equal to or higher than the reference voltage VREF2, the overcharge detection comparator 44 inverts the output voltage to Low. Then, the N type FET 14 is turned OFF, to thereby stop the charge to the battery 18.

[Operation when Battery 18 is in Overdischarge State]

A load (not shown) is connected to the battery pack 10. The reference voltage generation circuit 41 generates a reference voltage VREF1, which corresponds to an overdischarge voltage indicating that the battery 18 is in the overdischarge state. The overdischarge detection comparator 43 compares the divided voltage of the battery 18 with the reference voltage VREF1, and inverts an output voltage thereof depending on the comparison result. Specifically, if the divided voltage of the battery 18 becomes equal to or lower than the reference voltage VREF1, the overdischarge detection comparator 43 inverts the output voltage to Low. Then, the N type FET 13 is turned OFF, to thereby stop the discharge from the battery 18.

### [Operation Under High Temperature]

The temperature voltage generation circuit 55 generates a temperature voltage VTEMP, which is based on temperature. The temperature voltage generation circuit 55 has a feature that the temperature voltage VTEMP decreases as the temperature increases. The reference voltage generation circuit 51 generates a reference voltage VREF3, which corresponds to an abnormal high temperature to be detected. The high-temperature detection comparator 53 compares the temperature voltage VTEMP with the reference voltage VREF3, and inverts an output voltage thereof depending on the comparison result. Specifically, if the temperature voltage VTEMP decreases accompanying an increase in temperature and the temperature voltage VTEMP becomes equal to or lower than the reference voltage VREF3, the high-temperature detection comparator 53 inverts the output voltage to High. In other words, when the temperature increases to be equal to or higher than the abnormal high temperature, the high-temperature detection comparator 53 inverts the output voltage to High. Then, an output voltage of the NOR circuit 56 becomes Low, and the PMOS transistor 57 is turned ON to supply a current to the resistor 17, with the result that the resistor 17 generates a voltage to change a voltage of the output terminal DET to High from the high-impedance state. Then, the N type FET 15 is turned ON and the N type FET 14 is turned OFF, to thereby stop the charge to the battery 18.

### [Operation Under Low Temperature]

The reference voltage generation circuit 52 generates a reference voltage VREF4, which corresponds to an abnormal low temperature to be detected. The low-temperature detection comparator 54 compares the temperature voltage VTEMP with the reference voltage VREF4, and inverts an output voltage thereof depending on the comparison result. Specifically, if the temperature voltage VTEMP increases accompanying a decrease in temperature and the temperature voltage VTEMP becomes equal to or higher than the reference voltage VREF4, the low-temperature detection comparator 54 inverts the output voltage to High. In other words, when the temperature decreases to be equal to or lower than the abnormal low temperature, the low-temperature detection comparator 54 inverts the output voltage to High. Then, in the same manner as described above, the charge to the battery 18 is stopped.

With this configuration, regardless of whether or not the battery protection IC 11 has a terminal for the temperature protection of the battery pack 10, the battery pack 10 may implement the temperature protection by using the N type FET 15 and the resistor 17. Accordingly, there is no influence of the presence/absence of the terminal on implementing the temperature protection of the battery pack 10. Therefore, the battery pack 10 may implement the temperature protection with ease.

Further, the current flowing through the resistor 16 and the N type FET 15 is limited by the resistor 16. Therefore, current consumption during the turn-ON of the N type FET 15 is reduced.

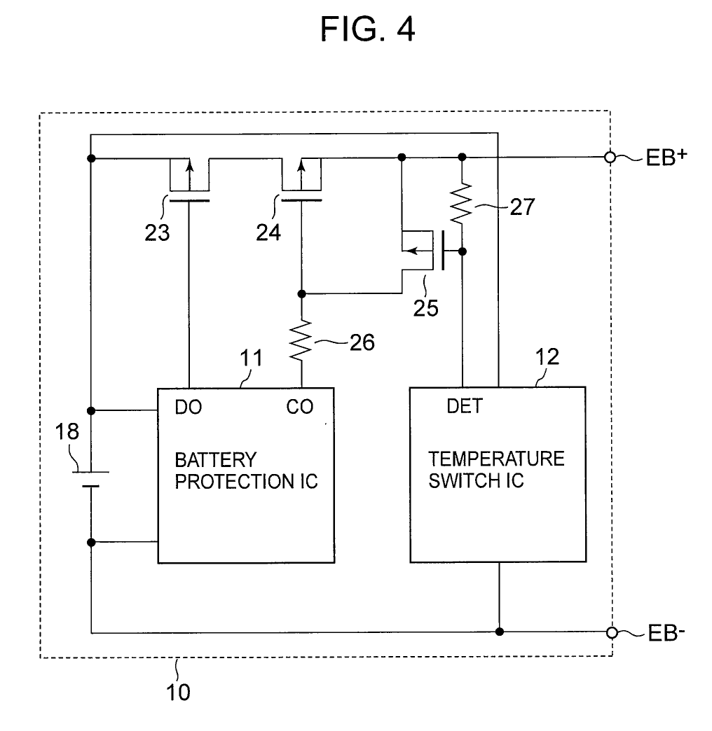

Note that, in FIG. 1, the N type FETs 13 and 14 are disposed between the external terminal EB− and the negative terminal of the battery 18. Alternatively, however, as illustrated in FIG. 4, P type FETs 23 and 24 may be disposed between the external terminal EB+ and the positive terminal of the battery 18. In this case, a resistor 26 is disposed between the charge control terminal CO and a connection point between a gate of the P type FET 24 and a drain of a P type FET 25. A resistor 27 is provided between the external terminal EB+ and a connection point between the output terminal DET and a gate of the P type FET 25. The P type FET 23 has a source and a back gate which are connected to the positive terminal of the battery 18, and a drain connected to a drain of the P type FET 24. The P type FET 24 has a source and a back gate which are connected to the external terminal EB+. The P type FET 25 has a source and a back gate which are connected to the external terminal EB+. Although not illustrated, an NMOS transistor is used as an open-drain output circuit of the temperature switch IC 12, though the PMOS transistor 57 is used in FIG. 3.

Further, although not illustrated, the N type FET 15, which is an element for turning OFF the N type FET 14 for charge control based on the voltage generated across the resistor 17, may be replaced with a bipolar transistor.

Still further, although not illustrated, the resistor 16 may be eliminated under a situation in which a negligibly small current flows through the resistor 16 and the N type FET 15.

Still further, although not illustrated, the resistor 16 may be built into the battery protection IC 11.

Still further, although not illustrated, the resistor 17 and the N type FET 15 may be built into the temperature switch IC 12.

As illustrated in FIG. 2, the overcharge detection comparator 44 and the overdischarge detection comparator 43 are required as the protecting function of the battery pack 10. However, although not illustrated, the overdischarge detection comparator 43 may be eliminated under a situation in which the specifications of the battery pack 10 allow for the elimination of the overdischarge detecting function included in the protecting function.

Further, as illustrated in FIG. 3, the high-temperature detection comparator 53 and the low-temperature detection comparator 54 are required as the protecting function of the battery pack 10. However, although not illustrated, the low-temperature detection comparator 54 may be eliminated under a situation in which the specifications of the battery pack 10 allow for the elimination of the low-temperature detecting function included in the protecting function.

Still further, similarly to the above, the high-temperature detection comparator 53 may be eliminated.

Further, any one of the following circuit designs may be made appropriately on the temperature switch IC 12: a temperature coefficient of the temperature voltage VTEMP based on a PNP bipolar transistor or an NPN bipolar transistor; the respective connection destinations of the non-inverting input terminal and the inverting input terminal of the high-temperature detection comparator 53; the respective connection destinations of the non-inverting input terminal and the inverting input terminal of the low-temperature detection comparator 54; the presence/absence of an inversion logic circuit provided at a subsequent stage of each comparator; and which one of the PMOS transistor and the NMOS transistor is included in the open-drain output circuit, so that the voltage of the output terminal DET is forcibly changed from the high-impedance state to High or Low when the temperature switch IC 12 detects an abnormal temperature.

Still further, in FIG. 2, the reference voltage generation circuits 41 and 42 are provided and each output the reference voltages VREF1 and VREF2, respectively. Alternatively, however, although not illustrated, a single reference voltage generation circuit may be provided and output the reference voltages VREF1 and VREF2. The same is applied to the reference voltage circuits 51 and 52 of FIG. 3.

What is claimed is:

1. A battery pack, comprising:
a temperature switch IC for supplying an output current when detecting an abnormal temperature;
a charge control FET and a discharge control FET which are connected in series in a charge/discharge path of a battery;
a first resistor for generating a voltage based on the output current;
a transistor for turning OFF the charge control FET based on the voltage generated across the first resistor; and
a battery protection IC for monitoring a charge state of the battery and controlling the charge control FET and the discharge control FET.

2. A battery pack according to claim 1, further comprising a second resistor disposed in a current path of an output current of the transistor.

3. A battery pack according to claim 2, wherein the second resistor is built into the battery protection IC.

4. A battery pack according to claim 1, wherein the first resistor and the transistor are built into the temperature switch IC.
